(19) United States
(12) Patent Application Publication
(10) Pub. No.: US 2011/0316474 A1
(43) Pub. Date: Dec. 29, 2011

(54) CHARGING APPARATUS FOR MOBILE BODY

(75) Inventors: Yuta KIMURA, SAITAMA (JP); Takuro KOYANAGI, SAITAMA (JP)

(73) Assignee: HONDA MOTOR CO., LTD., TOKYO (JP)

(21) Appl. No.: 13/169,276

(22) Filed: Jun. 27, 2011

(30) Foreign Application Priority Data
Jun. 29, 2010 (JP) 2010-147718

(51) Int. Cl. H02J 7/00

(52) U.S. Cl. 320/107

(57) ABSTRACT

A charging apparatus for a mobile body has a charging stand, which includes a connector holder to be connected to a battery of a walking robot, a forward/backward mechanism which moves the connector holder forward/backward, and a protrusion which is driven by the forward/backward mechanism to move forward/backward as the connector holder moves forward/backward. Control information indicating the state of the forward/backward mechanism when the protrusion is located in a predetermined position, which is detected on the basis of the detection values of a retreat position sensor and an advance position sensor, is acquired, and the forward/backward mechanism is controlled according to the acquired control information thereby to move the connector holder forward/backward.

### BACKGROUND OF THE INVENTION

1. Field of the Invention

The present invention relates to a charging apparatus for a mobile body, such as a robot.

2. Description of the Related Art

Hitherto, as a charging apparatus for a mobile body, such as a robot, there has been known one having a connector holder (connector) to be connected to a battery (secondary battery) of a mobile body and a forward/backward mechanism which moves the connector holder forward/backward.

For example, Japanese Patent Application Laid-Open No. 2009-113181 discloses a charging stand (charging apparatus) having a forward/backward mechanism which advances/retreats a movable frame (movable member) connected to a supporting frame (supporting member), which supports a connector holder, by a direct-acting driving source. In the charging stand, a side section of the direct-acting driving source is provided with a retreat position sensor which detects the movable frame when the movable frame reaches a predetermined retreat position and an advance position sensor which detects the movable frame when the movable frame reaches a predetermined advance position. Based on detection values of the position sensors, the forward/backward mechanism is controlled such that the movable frame, and consequently, the connector holder, stops in the retreat position and the advance position and performs forward/backward movements.

However, in the charging stand disclosed in Japanese Patent Application Laid-Open No. 2009-113181 mentioned above, when the charging stand is connected to a mobile body for the first time after its manufacture or the like, there has been a danger that the position sensors fail to accurately detect their initial positions due to assembly errors or the like of components. In this case, there is a problem in that the connector holder that has been advanced fails to stop in a desired stop position and therefore fails to be connected to a mobile body.

### SUMMARY OF THE INVENTION

The present invention has been made with a view to the background described above, and it is an object of the invention to provide a charging apparatus for a mobile body which is capable of causing a connector to securely stop in a predetermined position and causing the connector to advance/retreat.

To this end, a charging apparatus for a mobile body having a secondary battery in accordance with the present invention includes a connector to be connected to the secondary battery; a forward/backward mechanism which causes the connector to perform a forward/backward movement to move toward or away from the mobile body; a forward/backward member which is driven by the forward/backward mechanism and which advances/retreats as the connector advances/retreats; a first position sensor which detects the forward/backward member being located in a first position; a second position sensor which detects the forward/backward member being located in a second position; and a controller which controls the forward/backward mechanism on the basis of control information indicative of a state of the forward/backward mechanism, wherein the controller acquires first control information indicating the state of the forward/backward mechanism in a first state wherein the forward/backward member is located in the first position on the basis of a detection value of the first position sensor and second control information indicating the state of the forward/backward mechanism in a second state wherein the forward/backward member is located in the second position on the basis of a detection value of the second position sensor, and controls the forward/backward mechanism so as to cause the connector to advance and retreat to the position in the first state and the position in the second state on the basis of the acquired first and second control information.

There is a case where the position of a position sensor is dislocated from a designed position due to an assembly error or the like during manufacture. For example, as described in the aforesaid Japanese Patent Application Laid-Open No. 2009-113181, when a movable frame (corresponding to a movable member in the present invention), which moves forward/backward together with a connector, is controlled according to control information set in a design stage, and a position sensor detects the position of the movable frame, there are some cases where the connector fails to stop in a position corresponding to a position where the position sensor should detect the movable frame, which is processed as a failure.

The present invention is adapted to acquire the first and the second control information on the basis of the detection values of the first and the second position sensors even in the case described above, thus making it possible to securely stop the connector in the positions in the first and the second states.

In the present invention, the forward/backward mechanism may be configured to include a rotary driving source and a continuous belt member which is linearly moved forward/backward through the intermediary of a converting mechanism which converts the rotational drive of the rotary driving source into a rectilinear movement, and may be configured such that a supporting member, which supports the connector onto the continuous belt member, and the forward/backward member are connected.

Further, in the present invention, the forward/backward mechanism may be configured to include a linear actuator and a movable member which is advanced/retreated by the linear actuator, and may be configured such that a supporting member, which supports the connector onto the movable member, and the forward/backward member are connected.

Further, in the present invention, the first position sensor and the second position sensor may be provided in the first position and the second position, respectively, and may be configured to act as contact type sensors which detects that the forward/backward member is located in the first and the second positions through contact with the forward/backward mechanism.

Further, in the present invention, the first and the second position sensors may be configured to be non-contact type sensors which detect that the forward/backward member is located in the first and the second positions without contacting the forward/backward member. The first and the second position sensors may be configured such that one of the first and the second position sensors is a contact type sensor while the other is a non-contact type sensor.

Further, in the present invention, in the first state, the connector is preferably located in the retreat position where the connector has retreated from the secondary battery. Further, in the present invention, in the second state, the connector is preferably located in the advance position where the connector is connected to the secondary battery.

In these cases, it is possible to cause the connector to move backward/forward and to securely stop in the retreat position and the advance position.

Further, in the present invention, the controller preferably determines the central positions in the position ranges, in which the detection values are output, as the first and the second positions, respectively, on the basis of the states of the first and the second position sensors when the forward/backward member is located in the first and the second positions.

In this case, even if some of the detection values output by the first and the second position sensors when the forward/backward member is located in the first and the second positions are wrong or missing, the first and the second positions can be accurately determined.

### BRIEF DESCRIPTION OF THE DRAWINGS

FIG. 1 is a side view of a robot and a charging stand according to a first embodiment of the present invention;

FIG. 2 is a top plan view of an essential section of the charging stand;

FIG. 3 is a side view of the essential section of the charging stand;

FIG. 4 is a sectional view taken at line IV-IV in FIG. 2;

FIG. 5 is a sectional view taken at line V-V in FIG. 2;

FIG. 6 is a diagram illustrating positional learning;

FIG. 7 is a top plan view of an essential section of a charging stand according to a second embodiment of the present invention; and

FIG. 8 is a side view of a vehicle and a charging stand according to another embodiment of the present invention.

### DESCRIPTION OF THE PREFERRED EMBODIMENTS

Referring to the accompanying drawings, the following will describe a first embodiment of a charging apparatus for a mobile body according to the present invention, the mobile body being a robot.

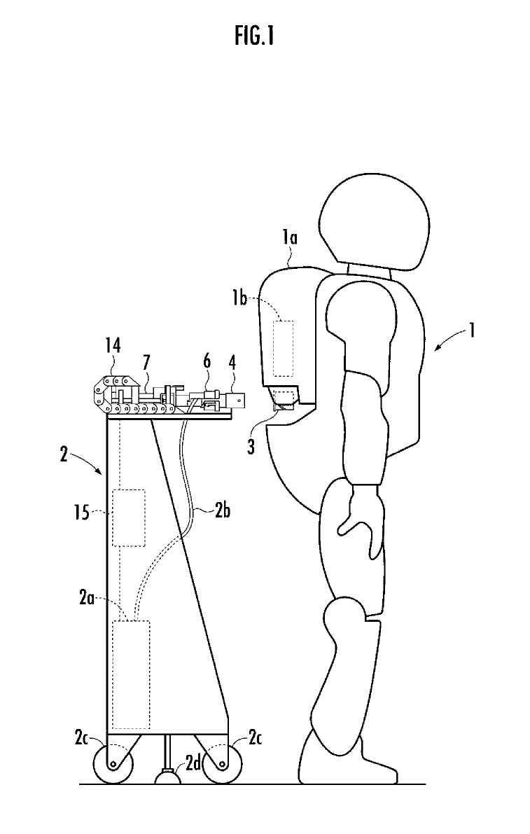

Referring to FIG. 1, the robot here is a humanoid walking robot 1. A battery 1b is housed in a control box 1a on the back of the walking robot 1, and the battery 1b is charged by a charging stand 2, which is a charging apparatus.

A power receiving connector 3 to be connected to the battery 1b is provided at the bottom of the control box 1a. Further, the charging stand 2 is provided with a charging power source 2a and a power feeding connector 4 to be connected to the charging power source 2a through a cable 2b.

When the remaining capacity of the battery 1b lowers, the walking robot 1 moves by itself to a place where the charging stand 2 is installed, and the power receiving connector 3 and the power feeding connector 4 are connected to charge the battery 1b by the charging power source 2a. The charging stand 2 can be freely moved on wheels 2c attached to the bottom end thereof. Further, the bottom end of the charging stand 2 is provided with a stopper 2d, which is threadedly screwed such that the stopper 2d is free to vertically move. By moving the stopper 2d downward, the charging stand 2 is fixed at a predetermined installation place.

Although not illustrated in detail, the power receiving connector 3 has a power receiving connector main body to be connected to the battery 1b, and a cylindrical power receiving connector housing, which extends in the longitudinal direction to accommodate the power receiving connector main body.

The following will describe the detailed construction of the charging stand 2. The direction in which the power feeding connector 4 is to be connected to the power receiving connector 3 is defined as “forward”, while the opposite direction thereof is defined as “backward”.

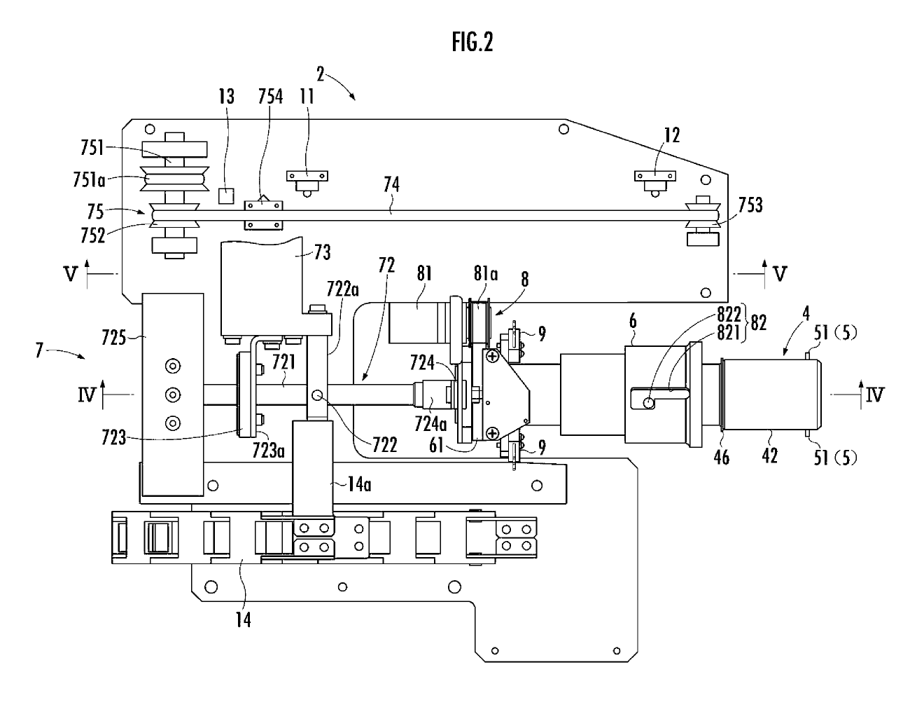

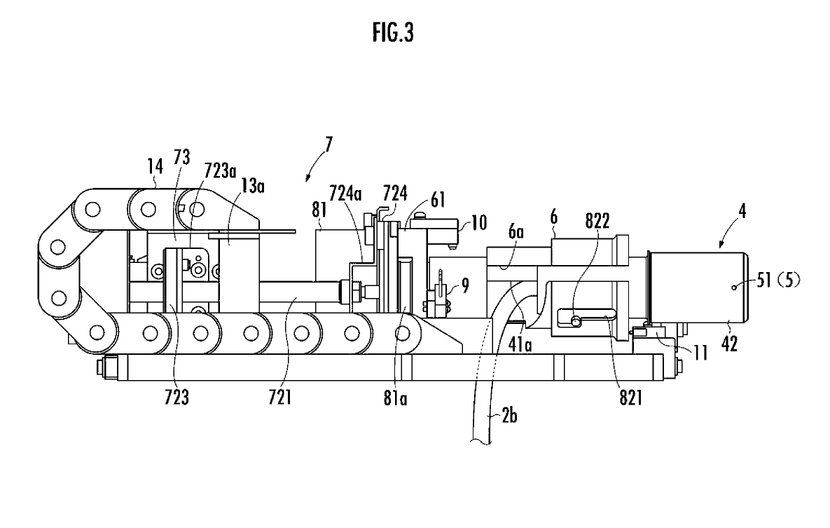

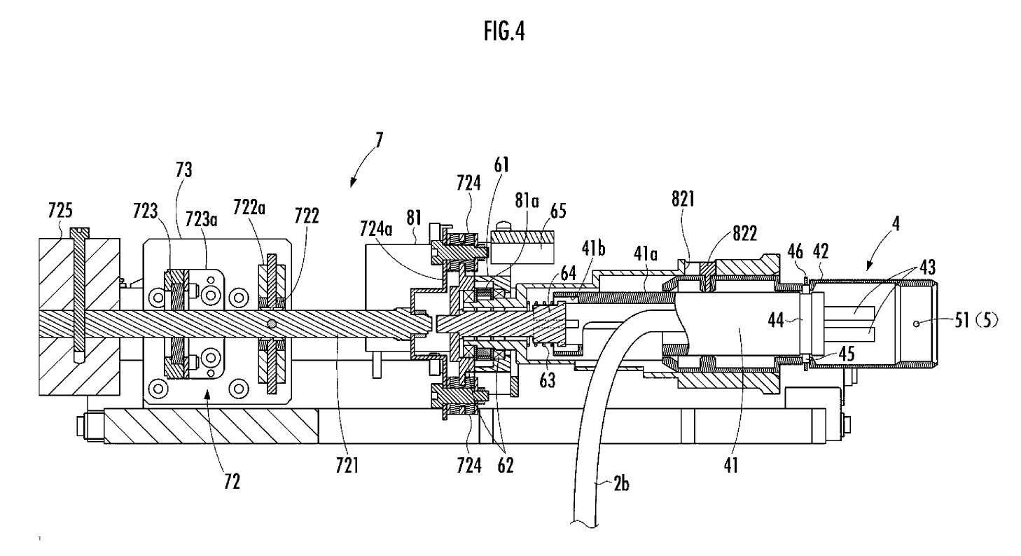

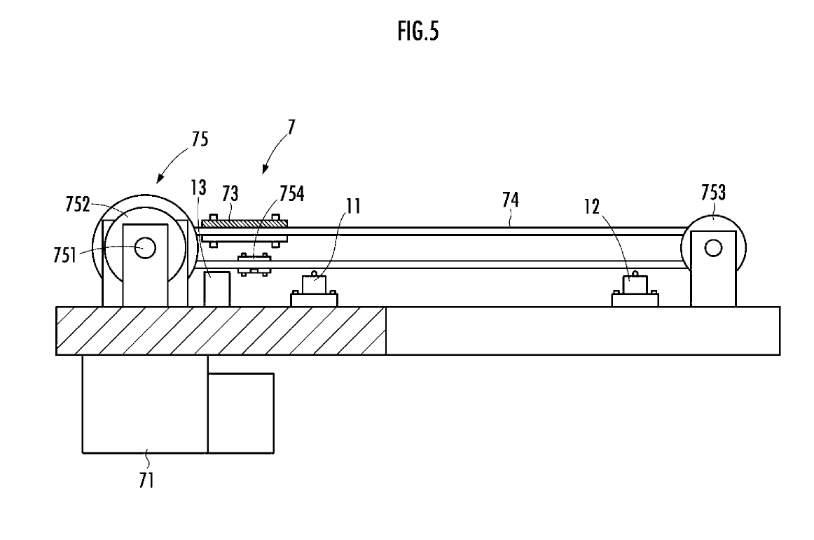

Referring to FIG. 2 to FIG. 5, the power feeding connector 4 has a power feeding connector main body 41 to be connected to the charging power source 2a through a cable 2b, and a power feeding connector housing 42, which is a cylindrical member extending in the longitudinal direction to accommodate the power feeding connector main body 41 and which internally fits in the power receiving connector housing in a detachable manner.

The power feeding connector main body 41 is provided with a plurality of male terminals 43 that projects toward the front. These terminals 43 fit into a plurality of female terminals provided in the power receiving connector main body thereby to electrically connect the power feeding connector 4 and the power receiving connector 3.

The power feeding connector housing 42 has a plurality of engaging pins 45, which engage an annular groove 44 formed in the outer peripheral surface of the power feeding connector main body 41, at intervals provided in the circumferential direction. Thus, the power feeding connector main body 41 is free to relatively rotate but immovable in the longitudinal direction with respect to the power feeding connector housing 42. The engaging pins 45 are prevented from slipping off by a stopper ring 46 attached to the outer periphery of the power feeding connector housing 42.

The power feeding connector main body 41 has a cable guide 41a projecting toward the rear of the power feeding connector housing 42, the cable 2b being led out downward from the cable guide 41a. Further, an orifice 41b having a cross-shaped section into which a guide rod 64 fits, which will be discussed later, is formed at the rear end of the cable guide 41a.

Further, a locking mechanism 5 is provided to lock the power feeding connector 4 in connection with the power receiving connector 3. The locking mechanism 5 is secured in the vicinity of the front end of the power feeding connector housing 42 and formed of a cam mechanism having a cam pin 51 that engages a threaded cam groove formed in the power receiving connector housing.

The charging stand 2 includes a connector holder 6 which detachably retains the power feeding connector 4, a forward/backward mechanism 7 which moves the connector holder 6 forward/backward in the longitudinal direction, and a locking control mechanism 8 which locks/unlocks the locking mechanism 5 through the intermediary of the connector holder 6. The connector holder 6 corresponds to a connector in the present invention.

The connector holder 6 is formed to have a cylindrical shape extending in the longitudinal direction to detachably accommodate the power feeding connector housing 42. Further, the rear end of the connector holder 6 is rotatively held by a bearing 62 in a supporting frame (supporting member) 61, which is moved forward/backward by the forward/backward mechanism 7. A relief orifice 6a for the cable 2b is formed in the peripheral wall of the connector holder 6.

The forward/backward mechanism 7 includes a servo motor 71, which is a rotary driving source, a movable frame (movable member) 73 to be linked to the supporting frame 61 through the intermediary of a floating mechanism 72, and a converting unit 75, which converts the rotational drive of the servo motor 71 into the forward/backward movement in the longitudinal direction of a belt (continuous belt member) 74 to which the movable frame 73 is secured. The movable frame 73 in FIG. 2 is illustrated with a part thereof torn off.

The floating mechanism 72 is constituted of a rod 721 extending in the longitudinal direction, a universal joint 722, which is attached to the movable frame 73 through the intermediary of a bracket 722a, has a freedom degree of two axes, and supports the rod 721 at its middle such that the rod 721 is free to tilt vertically and laterally, a first elastic supporting member 723, which is attached to the movable frame 73 through the intermediary of a bracket 723a and supports the rear end of the rod 721 elastically to permit displacement in the vertical and lateral directions, and a second elastic supporting member 724, which is provided at the front end of the rod 721 to elastically support the supporting frame 61 so as to permit tilting in the vertical and lateral directions.

The first elastic supporting member 723 is composed of a rubber bush through which the rod 721 penetrates. A balance weight 725 is attached to a part of the rod 721 that juts out to the rear of the first elastic supporting member 723. Further, the second elastic supporting member 724 is composed of a pair of rubber mounts, which is attached to the front end of the rod 721 through the intermediary of a bracket 724a and which connects the supporting frame 61 at two locations, namely, upper and lower locations.

Further, although not shown, the rear end of the power receiving connector housing has a tapered guide. When the connector holder 6 is advanced by the forward/backward mechanism 7, the force for correcting the decentering attributable to the guide causes the connector holder 6 to float in the vertical and lateral directions, thereby adjusting the position of the power feeding connector 4 to be concentric with the power receiving connector 3. Thus, the force for correcting the decentering caused by the guide formed at the rear end of the power receiving connector housing enables the rod 721 to tilt about the universal joint 722 with high follow-up.

Further, the second elastic supporting member 724 bends, causing the supporting frame 61 to tilt in the opposite direction from the direction into which the rod 721 tilts, so that the axis line of the power feeding connector 4 matches the axis line of the power receiving connector 3. Thus, the supporting frame 61, which supports the connector holder 6, is linked to the movable frame 73 through the intermediary of the floating mechanism 72 such that the supporting frame 61 is free to float in the vertical and lateral directions. Hence, the decentering between the power receiving connector 3 and the power feeding connector 4 can be corrected with high follow-up, enabling the power feeding connector 4 to be securely connected to the power receiving connector 3.

The converting unit 75 is constituted of a shaft 751, which is rotated by the servo motor 71 through the intermediary of a belt 751a, a drive pulley 752 secured to the shaft 751, and a driven pulley 753, which is rotatively provided by being spaced away from the drive pulley 752 in the longitudinal direction, a belt 74 being wound around the drive pulley 752 and the driven pulley 753. With this arrangement, the movable frame 73 secured to the belt 74 advances as the servo motor 71 is driven for normal rotation, while the movable frame 73 secured to the belt 74 retreats as the servo motor 71 is driven for reverse rotation. The belt 74 is preferably provided with a slip-proof member, such as a synchronous rotary belt. Alternatively, in place of the belt 74, a continuous belt member, such as a chain, may be used.

The locking control mechanism 8 is constituted of a rotary driving source 81 composed of an electric motor, which rotates the connector holder 6 in a locking direction and an unlocking direction, and a rotation transmitting unit 82 which rotates the power feeding connector housing 42 as the connector holder 6 rotates. The rotary driving source 81 is mounted on the supporting frame 61. Further, the connector holder 6 is rotated by the rotary driving source 81 through the intermediary of a belt 81a.

The rotation transmitting unit 82 is constructed of a guide groove 821 formed in the connector holder 6 and a guide pin 822, which is secured to the power feeding connector housing 42 and which engages the guide groove 821. The rotation of the connector holder 6 is transmitted to the power feeding connector housing 42 in a state wherein a relative longitudinal movement of the power feeding connector housing 42 is allowed.

The rear portion in the connector holder 6 is provided with an urging unit 63 composed of a coil spring which abuts the rear end of the cable guide 41a of the power feeding connector main body 41. The power feeding connector housing 42 is urged toward the front through the intermediary of the power feeding connector main body 41.

Further, a guide rod 64, which passes through the inner periphery of the rear end portion of the connector holder 6 and juts out into the connector holder 6, is secured to the supporting frame 61. The front portion of the guide rod 64 is formed to have a cross-shaped section, and the front portion fits into the orifice 41b having the cross-shaped section formed in the rear end of the cable guide 41a of the power feeding connector main body 41. Thus, the guide rod 64 functions as a stopper to prevent the power feeding connector main body 41 from rotating relative to the supporting frame 61.

The supporting frame 61 is further provided with a pair of rotational position sensors 9 and 9, which detect the connector holder 6 in a predetermined locking position and a predetermined unlocking position. Further, the supporting frame 61 is provided with a robot position sensor 10, which detects the position of the walking robot 1.

Provided on the sides of the belt 74 are a retreat position sensor 11, which is a first position sensor that detects a protrusion 754, which is secured to the belt 74, when the protrusion 754 is in a predetermined first position P1, and an advance position sensor 12, which is a second position sensor that detects the protrusion 754 when the protrusion 754 is located in a predetermined second position P2.

Here, the first position P1 is the position where the protrusion 754 is located when the movable frame 73 and the connector holder 6 are in predetermined retreat positions (retracted positions), and the second position P2 is set to the position where the protrusion 754 is located when the movable frame 73 and the connector holder 6 are in predetermined advance positions (power feeding positions). In other words, the connector holder 6 is located in the retreat position in the first state wherein the protrusion 754 is located in the first position P1, while the connector holder 6 is located in the advance position in the second state wherein the protrusion 754 is in the second position P2. A stopper 13 is fixed behind the retreat position sensor 11. The protrusion 754 is driven by the forward/backward mechanism 7 to move forward/backward as the connector holder 6 moves forward/backward and corresponds to the forward/backward member in the present invention.

The protrusion 754 has a projection jutting out toward the position sensors 11 and 12 and is secured to the belt 74 by bolting or the like. The position sensors 11 and 12 here are contact-type sensors and provided with retractable spherical members at the distal ends thereof. The position sensors 11 and 12 are configured to turn ON when the spherical members retreat, coming in contact with the projection of the protrusion 754.

The charging stand 2 further includes a wire supporting member 14, which is positioned besides the floating mechanism 72 to support wires for the rotary driving source 81, the rotary position sensor 9, and the robot position sensor 10. Further, the movable end of the wire supporting member 14 is connected to a bracket 722a for a universal joint 722 through the intermediary of a connecting piece 14a, so that the wire supporting member 14 moves, following the movable frame 73.

The charging stand 2 further includes a controller (control unit) 15 which controls the charging power source 2a. The cable 2b is provided with a signal line connected to the controller 15 in addition to a power feeding line connected to the charging power source 2a. Further, although not shown, the power feeding connector main body 41 and the power receiving connector main body are provided with signal terminals to allow signals to be transferred between the controller 15 and the walking robot 1 through the signal terminals.

The controller 15 is composed of a CPU, a ROM, a RAM, I/O and the like, and receives the signals from the rotation sensors 9, 9, the robot position sensor 10, the retreat position sensor 11, and the advance position sensor 12. The controller 15 outputs control signals to the servo motor 71 and the rotary driving source 81 on the basis of the input signals and control information, such as a step number N, stored in a memory thereof.

The following will describe the processing procedure for the initial setting of the charging stand 2. The forward/backward mechanism 7 is required to repeatedly and accurately move the connector holder 6 to the retreat position and the advance position. Hence, when the charging stand 2 is manufactured or reassembled or when the controller 15 is replaced or software is updated, the controller 15 learns control information corresponding to the retreat position and the advance position of the connector holder 6. The processing described below is carried out by the controller 15.

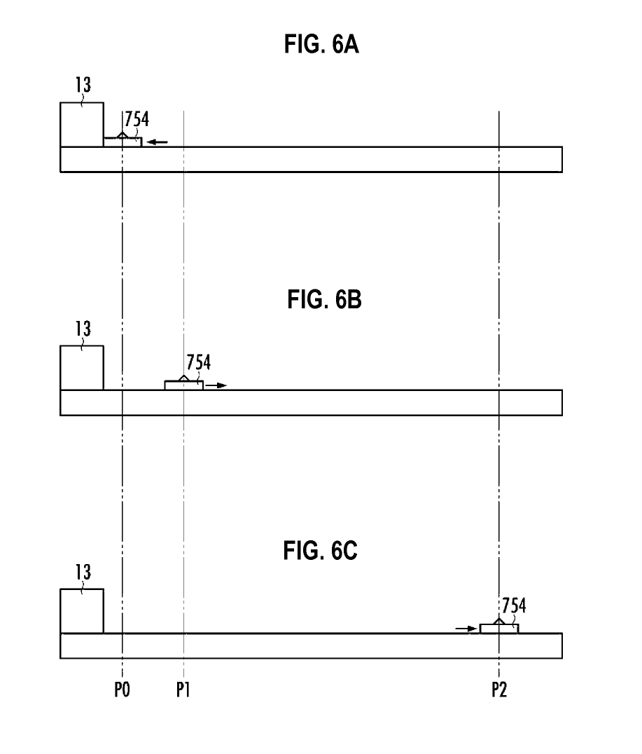

Referring to FIG. 6(a), the position of the protrusion 754 is undefined at the beginning, so that the servo motor 71 is driven for reverse rotation to move the protrusion 754 backward, and then the servo motor 71 is stopped when the protrusion 754 comes in contact with the stopper 13. This state is defined as an origin state wherein the protrusion 754 is located in an origin position P0, and the step number N stored in the memory is reset to, for example, zero.

Referring now to FIG. 6(b), the servo motor 71 is driven for normal rotation to move the protrusion 754 forward at a high speed and then at a very low speed (step-by-step) from a point immediately before the protrusion 754 reaches the first position P1. The step number N when the retreat position sensor 11 is ON is temporarily stored and the protrusion 754 completely passes the first position P1. Then, the intermediate value of a plurality of step numbers N for which the retreat position sensor 11 is ON is stored in the memory as a step number N1.

Referring now to FIG. 6(c), the servo motor 71 is driven for normal rotation to move the protrusion 754 forward at the high speed and then at the very low speed from a point immediately before the protrusion 754 reaches the second position P2. The step number N when the advance position sensor 12 is ON is temporarily stored and the protrusion 754 completely passes the second position P2. Then, the intermediate value of a plurality of step numbers N for which the advance position sensor 12 is ON is stored in the memory as a step number N2.

Thus, the step numbers N of the servo motor 71 when the connector holder 6 is in the retreat position and the advance position are stored in the memory as the step numbers N1 and N2, respectively.

The following will describe the processing procedure for charging the battery 1b, which is mounted on the walking robot 1, by the charging stand 2. When the remaining capacity of the battery 1b decreases, the walking robot 1 travels by itself to the place where the charging stand 2 is installed, and the walking robot 1 moves such that the power receiving connector 3 is properly directed to a position in front of the power feeding connector 4, as illustrated in FIG. 1. At this time, the protrusion 754 is in the first position P1, while the movable frame 73 is in the retreat position, and the step number N of the servo motor 71 is N1. The following processing is carried out by the controller 15.

When it is confirmed from an output signal from the robot position sensor 10 that the power receiving connector 3 is has been properly directed to a predetermined position in front of the power feeding connector 4, the step number N2 is acquired from the memory. Then, the servo motor 71 is driven in the normal direction of rotation for the step number N2. This causes the movable frame 73 and consequently the connector holder 6 to move forward to the advance position and then stop.

Here, the power feeding connector housing 42 (the power feeding connector 4) advances, following the connector holder 6. At the time of the advance, the guide formed at the rear end of the power receiving connector housing and the floating mechanism 72 work to perform positional adjustment such that the power feeding connector housing 42 is concentric with the power receiving connector housing.

Then, the locking control mechanism 8 locks the locking mechanism 5. More specifically, the connector holder 6 is rotated in the locking direction by a preset rotational angle by the rotary driving source 81, and it is confirmed by the rotary position sensor 9 that the connector holder 6 has reached the locking position. Thereafter, the locking mechanism 5 causes the power feeding connector housing 42 to advance toward the power receiving connector housing so as to lock the connection of the power feeding connector 4 to the power receiving connector 3.

Subsequently, it is checked according to the state of a signal between the aforesaid signal terminals whether the power feeding connector main body 41 has been connected to the power receiving connector main body. If the connection is confirmed and if it is determined that the charging is enabled from the state based on a signal, then predetermined charging to the battery 1b by the charging power source 2a is automatically started.

Upon completion of charging the battery 1b, the charging power source 2a continues to supply only the power necessary for the walking robot 1 to keep on standing at the place. If the walking robot 1 needs to detach itself from the charging stand 2, then the charging is stopped. When the charging is stopped, the locking control mechanism 8 unlocks the locking mechanism 5. More specifically, the connector holder 6 is rotated in the unlocking direction by a preset rotational angle by the rotary driving source 81, and then it is confirmed by the rotary position sensor 9 that the connector holder 6 has reached the unlocking position. Thereafter, the power feeding connector housing 42 retreats from the power receiving connector housing to draw the power feeding connector main body 41 away from the power receiving connector main body.

Subsequently, the step number N1 is acquired from the memory. Then, the servo motor 71 is driven in the reverse direction of rotation until the step number N1 is reached. This causes the movable frame 73 and consequently the connector holder 6 to move backward to the retreat position and stop. At this time, the power feeding connector housing 42 (the power feeding connector 4) detaches itself from the power receiving connector housing (the power receiving connector 3), returning to the state illustrated in FIG. 1. Thus, the walking robot 1 is completely set free.

As described above, the controller 15 acquires the step numbers N1 and N2 on the basis of the ON states of the position sensors 11 and 12, and the forward/backward mechanism 7 is controlled according to the acquired step numbers N1 and N2 so as to advance and retreat the connector holder 6 to the advance position and the retreat position. With this arrangement, even if the positions of the position sensors 11 and 12 are dislocated from designed setting positions due to assembly errors or the like during the manufacture, the connector holder 6 can be securely stopped at the retreat position and the advance position.

With reference to the accompanying drawings, the following will describe a second embodiment of the charging apparatus for a mobile body in accordance with the present invention, the mobile body being a walking robot 1. A charging stand 2A related to the charging apparatus of the second embodiment is similar to that in the first embodiment described above, so that only different aspects will be described.

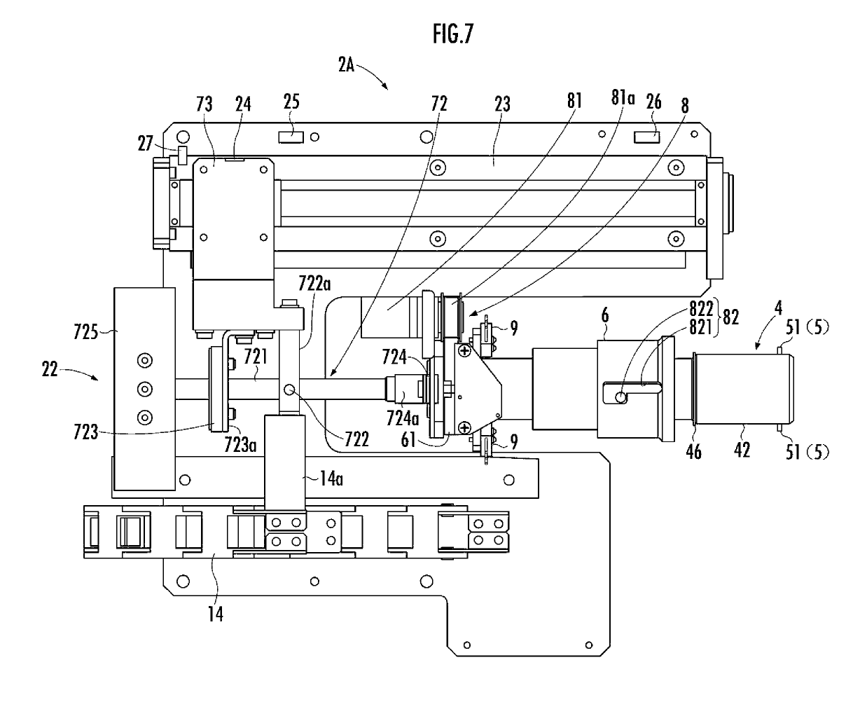

Referring to FIG. 7, the charging stand 2A is provided with a forward/backward mechanism 22 which moves a connector holder 6 forward/backward. The forward/backward mechanism 22 has a linear actuator 23 for moving a movable frame 73 forward/backward. The linear actuator 23 is a rodless cylinder and has a screw shaft, a servo motor for rotationally driving the screw shaft, and a mobile body which moves along the screw shaft as the screw shaft rotates and to which the movable frame 73 is secured. This arrangement causes the movable frame 73 to advance as the servo motor is driven for normal rotation, while causing the movable frame 73 to retreat as the servo motor is driven for reverse rotation.

Further, provided beside the movable frame 73 are a retreat position sensor 25, which detects a reflector 24 secured to a side surface of the movable frame 73 when the reflector 24 is in a predetermined first position P1, and an advance position sensor 26, which detects the reflector 24 when the reflector 24 is in a predetermined second position P2.

Here, the first position P1 is the position where the reflector 24 is located when the movable frame 73 and the connector holder 6 are in predetermined retreat positions (retracted positions), and the second position P2 is set to the position where the reflector 24 is located when the movable frame 73 and the connector holder 6 are in predetermined advance positions (power feeding positions). A stopper 27 is fixed behind the retreat position sensor 25. The reflector 24 is driven by the forward/backward mechanism 7 to move forward/backward as the connector holder 6 moves forward/backward and corresponds to a forward/backward member in the present invention.

Both of the position sensors 25 and 26 are noncontact type sensors. Here, each of the position sensors has a light emitter, which emits infrared rays, and a light receiver, which receives the infrared rays. The position sensors 25 and 26 are configured such that they turn on when their light receivers receive the infrared rays emitted from the light emitters and reflected on the reflector 24.

The following will describe the processing procedure for carrying out the initial setting of the charging stand 2A. The following processing is carried out by a controller 15.

The position of the reflector 24 of the movable frame 73 is undefined at the beginning, so that the servo motor is driven for reverse rotation to move the movable frame 73 backward, and then the servo motor is stopped when the movable frame 73 comes in contact with a stopper 27. This state is defined as an origin state wherein the reflector 24 is located in an origin position P0, and a step number N stored in a memory is reset to, for example, zero.

Subsequently, the servo motor is driven for normal rotation to move the movable frame 73 forward at a high speed and then at a very low speed (step-by-step) from a point which is a little before the reflector 24 reaches a first position. The step number N when the retreat position sensor 25 is ON is temporarily stored and the reflector 24 completely passes the first position. Then, the intermediate value of a plurality of step numbers N for which the retreat position sensor 25 is ON is stored in the memory as a step number N1.

Subsequently, the servo motor is driven for normal rotation to move the movable frame 73 forward at the high speed and then at the very low speed from a point which is a little before the reflector 24 reaches a second position. The step number N when the advance position sensor 26 is ON is temporarily stored and the reflector 24 completely passes the second position. Then, the intermediate value of a plurality of step numbers N for which the advance position sensor 26 is ON is stored in the memory as a step number N2.

Thus, the step numbers N of the servo motor when the connector holder 6 is in the retreat position and a power feeding position are stored in the memory as step numbers N1 and N2, respectively.

The following will describe the processing procedure for charging a battery 1b, which is mounted on a walking robot 1, by a charging stand 2A. When the remaining capacity of the battery 1b decreases, the walking robot 1 travels by itself to the place where the charging stand 2A is installed, and the walking robot 1 moves such that a power receiving connector 3 is properly directed to a position in front of a power feeding connector 4, as illustrated in FIG. 1. At this time, the reflector 24 is in the first position, while the movable frame 73 is in the retreat position, and the step number N of the servo motor is N1. The following processing is carried out by the controller 15.

When it is confirmed from an output signal from a robot position sensor 10 that the power receiving connector 3 has been properly directed to a predetermined position in front of the power feeding connector 4, the step number N2 is acquired from the memory. Then, the servo motor is driven in the normal direction of rotation until the step number N2 is reached. This causes the movable frame 73 and consequently the connector holder 6 to move forward to the advance position and then stop.

Here, the power feeding connector housing 42 (the power feeding connector 4) advances, following the connector holder 6. Then, a locking control mechanism 8 locks a locking mechanism 5.

Subsequently, it is checked according to the state of a signal between signal terminals whether a power feeding connector main body 41 has been connected to a power receiving connector main body. If the connection is confirmed and if it is determined that the charging is enabled from the state based on the signal, then predetermined charging to the battery 1b by a charging power source 2a is automatically started.

Upon completion of charging the battery 1b, the charging power source 2a continues to supply only the power necessary for the walking robot 1 to keep on standing at the place. If the walking robot 1 needs to detach itself from the charging stand 2, then the charging is stopped. When the charging is stopped, the locking control mechanism 8 unlocks the locking mechanism 5.

Subsequently, the step number N1 is acquired from the memory. Then, the servo motor is driven in the reverse direction of rotation until the step number N1 is reached. This causes the movable frame 73 and consequently the connector holder 6 to move backward to the retreat position and stop. At this time, the power feeding connector housing 42 (the power feeding connector 4) detaches itself from the power receiving connector housing (the power receiving connector 3), returning to the state illustrated in FIG. 1. Thus, the walking robot 1 is completely freed.

As described above, the controller 15 acquires the step numbers N1 and N2 on the basis of the ON states of the position sensors 25 and 26, and the forward/backward mechanism 7 is controlled according to the acquired step numbers N1 and N2 so as to advance and retreat the power feeding connector 4 to the advance position and the retreat position. Thus, the second embodiment provides the same advantages as those of the first embodiment described above.

Although the embodiments of the present invention have been described with reference to the attached drawings, the present invention is not limited thereto. For example, in the first embodiment, the position of the protrusion 754 secured to the belt 74 has been detected by the position sensors 11 and 12 composed of the contact-type sensors; however, a reflector or the like may be secured to the belt 74 and the position of the reflector or the like may be detected using noncontact-type sensors. Further, in the second embodiment, the position of the reflector 24 secured to the movable frame 73 has been detected using the position sensors 25 and 26 composed of the noncontact-type sensors. Alternatively, however, the movable frame 73 may be provided with a projection or the like, and the position of the projection or the like may be detected using contact-type sensors.

Further, the position sensors 11, 12, 25 and 26 have been described in the case where the position sensors are configured to turn ON when the connector holder 6 is in the advance position or the retreat position; however, the present invention is not limited thereto. For example, the position sensors 11, 12, 25 and 26 may be configured to output different signals, depending on whether the connector holder 6 is in the advance position or the retreat position or in any other positions.

The construction of the forward/backward mechanism is not limited to the ones described in the embodiments. Further, appropriate control information may be acquired according to the driving source of the forward/backward function.

The embodiments have been described by taking the walking robot 1 as an example that corresponds to the mobile body in the present invention; however, the present invention is not limited thereto. For example, the mobile body may be a robot that travels by using wheels or spherical members or the like.

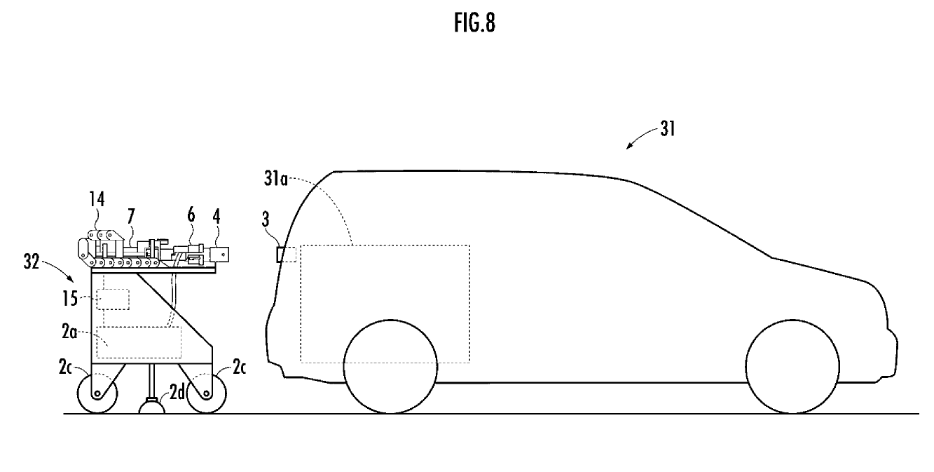

Further, referring to FIG. 8, an object corresponding to the mobile body of the present invention may be a vehicle 31. The vehicle 31 has a battery 31a, and the battery 31a is charged by a charging stand 32, which is a charging apparatus. The charging stand 32 is provided with a power feeding connector 4, which is appropriately installed to match the height of a power receiving connector 3 to be connected to the battery 31a. The charging stand 32 has the same construction as those of the charging stands 2 and 2A described above, so that the description thereof will be omitted. The mobile body in the present invention is not limited to those in the aforesaid embodiments, and may be an endless track type mobile body, a vessel or the like.

What is claimed is:

1. A charging apparatus for a mobile body having a secondary battery, comprising:
a connector to be connected to the secondary battery;
a forward/backward mechanism which causes the connector to perform a forward/backward movement to move toward or away from the mobile body;
a forward/backward member which is driven by the forward/backward mechanism and which advances/retreats as the connector advances/retreats;
a first position sensor which detects the forward/backward member being located in a first position;
a second position sensor which detects the forward/backward member being located in a second position; and
a controller which controls the forward/backward mechanism on the basis of control information indicative of a state of the forward/backward mechanism,
wherein the controller acquires first control information indicating the state of the forward/backward mechanism in a first state wherein the forward/backward member is located in the first position on the basis of a detection value of the first position sensor and second control information indicating the state of the forward/backward mechanism in a second state wherein the forward/backward member is located in the second position on the basis of a detection value of the second position sensor, and controls the forward/backward mechanism so as to cause the connector to advance and retreat to the position in the first state and the position in the second state on the basis of the acquired first and second control information.

2. The charging apparatus according to claim 1, wherein
the forward/backward mechanism comprises a rotary driving source and a continuous belt member which is linearly moved forward/backward through the intermediary of a converting mechanism which converts the rotational drive of the rotary driving source into a rectilinear movement, and
a supporting member, which supports the connector onto the continuous belt member, and the forward/backward member are connected.

3. The charging apparatus according to claim 1, wherein
the forward/backward mechanism comprises a linear actuator and a movable member which is advanced/retreated by the linear actuator, and
a supporting member, which supports the connector onto the movable member, and the forward/backward member are connected.

4. The charging apparatus according to claim 1, wherein the first and the second position sensors are provided in the first and the second positions, respectively, and are contact type sensors which detect that the forward/backward member is located in the first and the second positions through contact with the forward/backward mechanism.

5. The charging apparatus according to claim 2, wherein the first and the second position sensors are provided in the first and the second positions, respectively, and are contact type sensors which detect that the forward/backward member is located in the first and the second positions through contact with the forward/backward mechanism.

6. The charging apparatus according to claim 3, wherein the first and the second position sensors are provided in the first and the second positions, respectively, and are contact type sensors which detect that the forward/backward member is located in the first and the second positions through contact with the forward/backward mechanism.

7. The charging apparatus according to claim 1, wherein the first and the second position sensors are non-contact type sensors which detect that the forward/backward member is located in the first and the second positions without contacting the forward/backward member.

8. The charging apparatus according to claim 2, wherein the first and the second position sensors are non-contact type sensors which detect that the forward/backward member is located in the first and the second positions without contacting the forward/backward member.

9. The charging apparatus according to claim 3, wherein the first and the second position sensors are non-contact type sensors which detect that the forward/backward member is located in the first and the second positions without contacting the forward/backward member.

10. The charging apparatus according to claim 1, wherein in the first state, the connector is located in the retreat position where the connector has retreated from the secondary battery.

11. The charging apparatus according to claim 2, wherein in the first state, the connector is located in the retreat position where the connector has retreated from the secondary battery.

12. The charging apparatus according to claim 3, wherein in the first state, the connector is located in the retreat position where the connector has retreated from the secondary battery.

13. The charging apparatus according to claim 1, wherein in the second state, the connector is located in the advance position where the connector is connected to the secondary battery.

14. The charging apparatus according to claim 2, wherein in the second state, the connector is located in the advance position where the connector is connected to the secondary battery.

15. The charging apparatus according to claim 3, wherein in the second state, the connector is located in the advance position where the connector is connected to the secondary battery.

16. The charging apparatus according to claim 10, wherein in the second state, the connector is located in the advance position where the connector is connected to the secondary battery.

17. The charging apparatus according to claim 1, wherein the controller determines the central positions in the position ranges, in which the detection values are output, as the first and the second positions, respectively, on the basis of the states of the first and the second position sensors when the forward/backward member is located in the first and the second positions.

18. The charging apparatus according to claim 2, wherein the controller determines the central positions in the position ranges, in which the detection values are output, as the first and the second positions, respectively, on the basis of the states of the first and the second position sensors when the forward/backward member is located in the first and the second positions.

19. The charging apparatus according to claim 3, wherein the controller determines the central positions in the position ranges, in which the detection values are output, as the first and the second positions, respectively, on the basis of the states of the first and the second position sensors when the forward/backward member is located in the first and the second positions.

20. The charging apparatus according to claim 4, wherein the controller determines the central positions in the position ranges, in which the detection values are output, as the first and the second positions, respectively, on the basis of the states of the first and the second position sensors when the forward/backward member is located in the first and the second positions.
